(19) United States
(12) Patent Application Publication
(10) Pub. No.: US 2026/0319480 A1
(43) Pub. Date: Oct. 15, 2026

(54) LEARNING DEVICE, NUMERICAL CONTROL DEVICE, MACHINING RESULT PREDICTION METHOD, AND MACHINING SYSTEM

(71) Applicant: Mitsubishi Electric Corporation, Tokyo (JP)

(72) Inventors: Kenta FUJII, Tokyo (JP); Kyohei ISHIKAWA, Tokyo (JP); Takeru MINAMIDA, Tokyo (JP); Teruaki FUKUOKA, Tokyo (JP)

(73) Assignee: Mitsubishi Electric Corporation, Tokyo (JP)

(21) Appl. No.: 19/119,115

(22) PCT Filed: Oct. 21, 2022
(86) PCT No.: PCT/JP2022/039316

§ 371 Date: Apr. 8, 2025

(51) Int. Cl. G05B 19/418

(52) U.S. Cl. CPC G05B 19/41885; G05B 2219/42152

(57) ABSTRACT

A learning device includes a recording unit that records, as first reference information, sensor information that is a sensor signal or a feature of the sensor signal which indicates an observation result of at least one of a state of a workpiece and a state of a machining device when machining with a reference machining parameter is executed by the first machining device; a reference information acquisition unit that acquires, as second reference information, the sensor information when machining with the reference machining parameter is executed by the second machining device; and a correction function learning unit that learns a correction function to be used, when the sensor information is subjected to correction and then input to the model in the second machining device, for the correction so that a feature of the second reference information after correction is caused to approximate a feature of the first reference information.

### FIELD

The present disclosure relates to a learning device that generates a learning model to be applied to an industrial machine, a numerical control device, a machining result prediction method, and a machining system.

### BACKGROUND

As an example of a conventional device realized by applying a learning model, for example, Patent Literature 1 discloses an anomaly determination device including: an observation data acquisition unit that acquires observation data regarding an operation observed during the operation of an industrial machine; a correction unit that corrects the observation data depending on an operation condition of the industrial machine; a statistic extraction unit that extracts, from the observation data, partial time-series data including a portion in which a feature of an operating state at predetermined timing appears, and calculates at least one statistic from the partial time-series data; and a machine learning device that executes a process of machine learning for determining an operation anomaly of the industrial machine on the basis of the statistic calculated by the statistic extraction unit.

### CITATION LIST

### Patent Literature

Patent Literature 1: Japanese Patent Application Laid-open No. 2021-15573

### SUMMARY OF INVENTION

### Problem to be Solved by the Invention

In the generation of a learning model, it is necessary to prepare a lot of learning data to perform machine learning, which requires a lot of time and effort. Therefore, regarding a learning model obtained by performing machine learning with the use of learning data collected by operating one industrial machine, use thereof in another industrial machine of the same type has been explored. By generating a learning model with the use of learning data acquired from one industrial machine and using the learning model in a plurality of industrial machines of the same type, the necessity to perform machine learning for each industrial machine to generate a learning model is eliminated, and time and effort for preparing a learning model can be reduced.

On the other hand, it is known that in the use of a learning model, a small difference in input to the learning model may greatly affect the output of the learning model. For example, in a case where a learning model is used in prediction of an operation result of a machining device, even if the same machining parameter is set to machining devices having the same design and machining is performed, a difference occurs between obtained data due to a difference in characteristics between tools used for machining, a difference in characteristics between workpieces, an individual difference between sensors each constituting an acquisition unit for data input to the learning model, and the like. Therefore, in a case where a learning model generated by performing machine learning with the use of data collected by a certain machining device is installed on another machining device, errors in the output of the learning model increase, which may result in inaccuracy.

In the anomaly determination device described in Patent Literature 1, when a certain industrial machine learns observation data, the industrial machine is operated to correct the acquired observation data depending on each of a plurality of operating conditions, and a learning model is generated by using the corrected observation data. Therefore, the learning can be completed in a small number of times. However, in a case where a learning model generated by a certain industrial machine is applied to another industrial machine, a difference occurs between observation data to be acquired for a determination process from industrial machines due to a difference in characteristics between tools used in machining by the industrial machines, a difference in characteristics between workpieces, an individual difference between sensors that observe operations, and the like. As a result, there arises a problem that errors in the output of the learning model increase, which results in an inaccurate determination result.

The present disclosure has been made in view of the above, and an object thereof is to provide a learning device that, when a learning model generated by learning an operation of a certain industrial machine is applied to another industrial machine, is capable of preventing determination accuracy of the learning model in the another industrial machine from decreasing.

### Means to Solve the Problem

To solve the above problem and achieve an object, a learning device according to the present disclosure includes, when a model is used in a second machining device, the model being learned by associating sensor information acquired by an observation unit of a first machining device and labels corresponding to the sensor information, the first machining device being a machining device that performs machining in accordance with machining parameters, and includes the observation unit that acquires, during machining, any one of a sensor signal and a feature of the sensor signal as sensor information, the sensor signal indicating an observation result of at least one of a state of a workpiece and a state of a machining device, the second machining device being the machining device different from the first machining device: a recording unit to record, as first reference information, the sensor information when machining with a reference machining parameter that is one of the machining parameters is executed by the first machining device; a reference information acquisition unit to acquire, as second reference information, the sensor information when machining with the reference machining parameter is executed by the second machining device; and a correction function learning unit to learn a correction function to be used, when the sensor information is subjected to correction and then input to the model in the second machining device, for the correction so that a feature of the second reference information after correction is caused to approximate a feature of the first reference information.

### Effects of the Invention

The present disclosure achieves an effect that it is possible to realize a learning device that, when a learning model generated by learning an operation of a certain industrial machine is applied to another industrial machine, is capable of preventing determination accuracy of the learning model in the another industrial machine from decreasing.

### BRIEF DESCRIPTION OF DRAWINGS

FIG. 1 is a diagram illustrating an exemplary configuration of a machining system according to a first embodiment.

FIG. 2 is a diagram illustrating a method for creating a model used in the machining system according to the first embodiment.

FIG. 3 is a diagram illustrating an exemplary configuration of an observation unit of a first machining device.

FIG. 4 is a diagram illustrating an exemplary configuration of an observation unit of a second machining device.

FIG. 5 is a flowchart illustrating an example of an operation of a learning device.

FIG. 6 is a diagram for explaining an example of an operation in which a correction function learning unit of the learning device selects data to be used for learning of a correction function.

FIG. 7 is a diagram illustrating an example of hardware that realizes the learning device.

FIG. 8 is a diagram illustrating an exemplary configuration of an observation unit included in a first machining device of a machining system according to a second embodiment.

FIG. 9 is a diagram illustrating an exemplary configuration of an observation unit included in a second machining device of the machining system according to the second embodiment.

FIG. 10 is a diagram illustrating an exemplary configuration of a machining system according to a third embodiment.

### DESCRIPTION OF EMBODIMENTS

Hereinafter, a learning device, a numerical control device, a machining result prediction method, and a machining system according to each embodiment of the present disclosure will be described in detail with reference to the drawings.

### First Embodiment

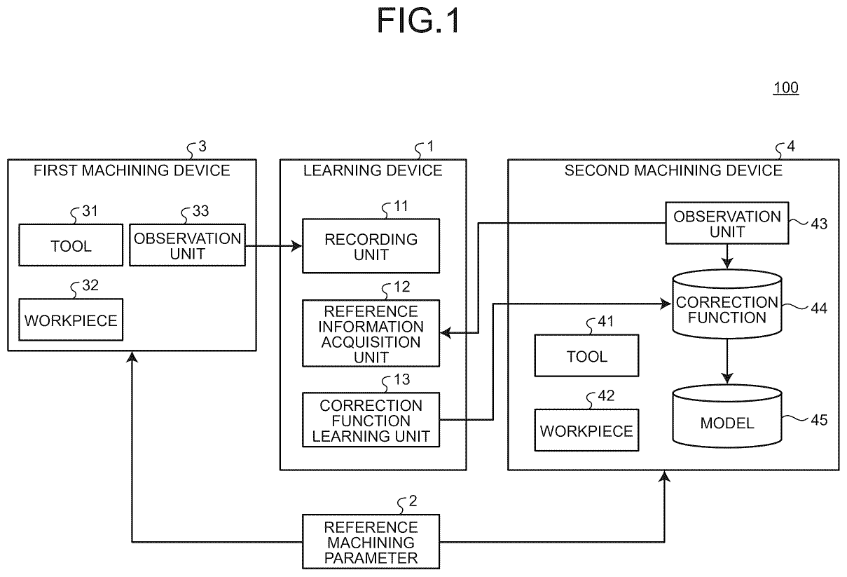

FIG. 1 is a diagram illustrating an exemplary configuration of a machining system 100 according to a first embodiment. The machining system 100 includes a learning device 1, a first machining device 3, and a second machining device 4. The first machining device 3 and the second machining device 4 are machining devices of the same type. Here, what is meant by the same type is that the machining devices have similar functions and can perform similar machining on workpieces that are machining target objects. The content of machining performed by the first machining device 3 and the second machining device 4 follow the setting of machining parameter to be described later. Although details will be described later, in the machining system 100 illustrated in FIG. 1, when the learning device 1 performs learning, a reference machining parameter 2 is set as the same machining parameter for the first machining device 3 and the second machining device 4. When the learning device 1 does not perform learning, a machining parameter is individually set for each of the first machining device 3 and the second machining device 4.

The learning device 1 includes a recording unit 11, a reference information acquisition unit 12, and a correction function learning unit 13. The first machining device 3 includes a tool 31, a workpiece 32, and an observation unit 33. The second machining device 4 includes a tool 41, a workpiece 42, an observation unit 43, a correction function 44, and a model 45. Note that each of the first machining device 3 and the second machining device 4 includes a numerical control device and a drive unit for changing relative positions of the tool and the workpiece, which are not illustrated. Although the model 45 is included in the second machining device 4 in FIG. 1, a device different from the second machining device 4 may include the model 45. For example, a device having a function of predicting a result of machining of the workpiece 42 by the second machining device 4 may include the model 45, and this device may predict the machining result by using the model 45.

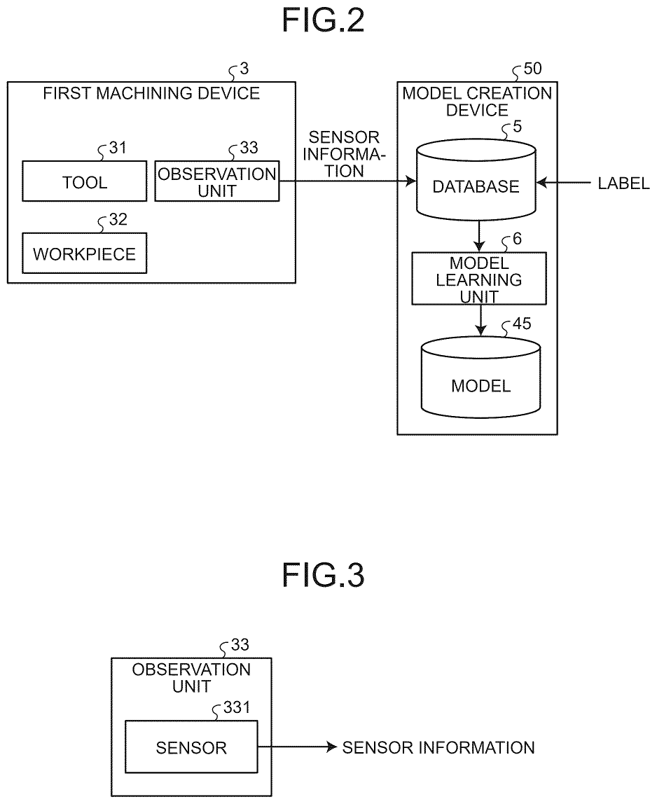

FIG. 2 is a diagram illustrating a method for creating the model 45 used in the machining system 100 according to the first embodiment. The model 45 is created by a model creation device 50 on the basis of sensor information collected by the first machining device 3 illustrated in FIG. 1 and labels. The model creation device 50 includes a database 5 in which the sensor information and the labels are registered, and a model learning unit 6 that creates the model 45 by learning a relationship between the sensor information and the labels registered in the database 5. The first machining device 3 and the model creation device 50 may be directly connected by a communication cable or the like, or may be connected via a communication network.

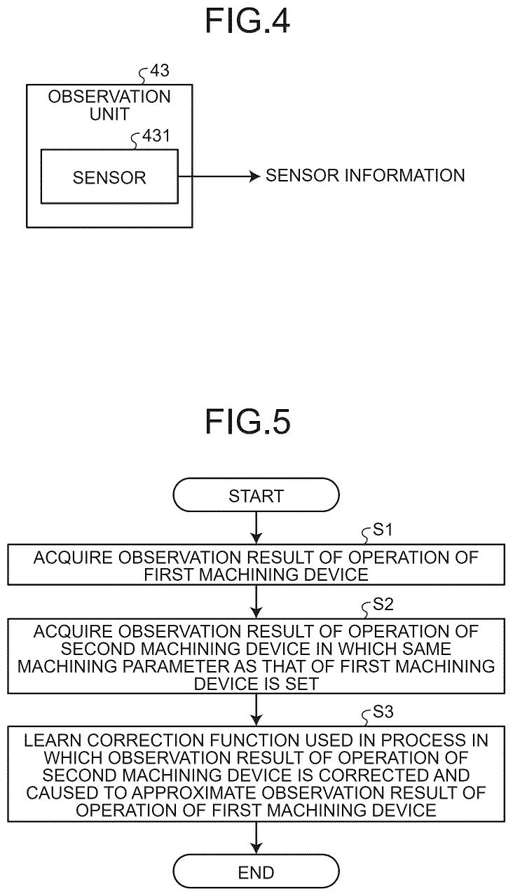

The observation unit 33 of the first machining device 3 and the observation unit 43 of the second machining device 4 have configurations illustrated in FIGS. 3 and 4, respectively. FIG. 3 is a diagram illustrating an exemplary configuration of the observation unit 33 of the first machining device 3, and FIG. 4 is a diagram illustrating an exemplary configuration of the observation unit 43 of the second machining device 4. As illustrated in FIG. 3, the observation unit 33 of the first machining device 3 includes a sensor 331, and observes the state of the first machining device 3 by using the sensor 331. The sensor 331 outputs a sensor signal indicating an observation result. The observation unit 33 may observe the state of the workpiece 32 and use a result of the observation as an observation result obtained by the first machining device 3. That is, the sensor signal output from the sensor 331 may indicate the observation result of the workpiece 32. The observation unit 43 of the second machining device 4 includes a sensor 431, and observes the state of the second machining device 4 by using the sensor 431. The sensor 431 outputs a sensor signal indicating an observation result. The observation unit 43 may observe the state of the workpiece 42 and use a result of the observation as an observation result obtained by the second machining device 4. That is, the sensor signal output from the sensor 431 may indicate the observation result of the workpiece 42. Although the sensor 331 and the sensor 431 are the same type of sensors, there is an individual difference therebetween, and even when the same object is observed under the same condition, there may a difference between an observation result obtained by the sensor 331 and an observation result obtained by the sensor 431.

Here, specific examples of a machining device used as the first machining device 3 and the second machining device 4 include a turning device, a milling device, a grinding device, a laser machining device, an electrical discharge machining device, a water jet machining device, and a press machining device.

The state of a machining device is the state of the machining device expressed as data or observed, and examples thereof include whether a drive unit is normal or anomalous, a current flowing through the drive unit, the magnitude of a voltage applied to the drive unit, sound or light generated at the time of machining, a temperature, a position, a speed, acceleration, an angle, an angular velocity, angular acceleration, a pressure, and the amount of deformation of a specific part, the degree of wear of a tool, and an image of the specific part.

The state of the workpiece 32 is a value obtained by observing how the workpiece 32 is machined, and examples thereof include acceleration that can be acquired by an acceleration sensor attached to the workpiece 32, an angular velocity that can be acquired by a gyro sensor, an observation value obtained by an optical sensor if light emission occurs during machining, and a temperature of the workpiece. The same applies to the state of the workpiece 42.

The items to be observed by the observation unit 33 and the observation unit 43 and values thereof are usually in association with items to be predicted by outputs of the model 45. Therefore, it is necessary to devise the type of each sensor used in the observation unit 33 and the observation unit 43 depending on the items to be desirably predicted by the model 45 and the type of the machining device to which the model 45 is applied. In addition, as sensors used in the observation unit 33 and the observation unit 43, a plurality of sensors may be used in combination depending on a purpose.

The machining parameter is a set of variables in association with a machining operation set in a machining device. Examples of a value set as the machining parameter include a machining speed indicating the speed of the machining operation, a limit value of the acceleration of a movable portion, a value specifying a relationship between relative positions of a tool and a workpiece, and specified values of the amounts of cutting liquid and oil used to assist machining.

In one example, if the machining device is a turning device, values of a machining speed, the amount of cutting, a rotational speed of a workpiece, the amount of cutting liquid and the like are set for the machining parameter as a set of variables. In another example, if the machining device is a laser machining device, laser output, a focal position, a beam shape, a machining speed, a machining gas species, a machining gas pressure, a nozzle height and the like are set for the machining parameter as a set of variables.

A part or all of the learning device 1 may be included in the first machining device 3 or may be provided outside the first machining device 3. A part or all of the learning device 1 may be provided in a numerical control device constituting the first machining device 3. A part or all of the learning device 1 may be provided in the second machining device 4. Alternatively, a configuration can be employed in which the first machining device 3 is connected to a cloud via a network, and all or part of the learning device 1 is implemented by a processing circuit of a cloud server.

The first machining device 3 that is a first machining device machines the workpiece 32 by using the tool 31 in accordance with a machining parameter and a machining program. The observation unit 33 acquires the state of at least one of the workpiece 32 and the first machining device 3 as sensor information.

As illustrated in FIG. 2, the model 45 is created by the model learning unit 6 of the model creation device 50 on the basis of the sensor information collected by the first machining device 3 and the labels. Specifically, the first machining device 3 machines the workpiece 32, and records and accumulates the sensor information obtained from the observation unit 33 and the labels corresponding to the sensor information in the database 5 of the model creation device 50. The model learning unit 6 outputs the model 45 that has learned the relationship between the sensor information and the labels accumulated in the database 5. When the model learning unit 6 learns the relationship between the sensor information and the labels, features may be extracted from the sensor information, and a relationship between the features of the sensor information and the labels may be learned. When the relationship between the features of the sensor information and the labels has been learned, a feature is extracted with respect to sensor information given at the time of using the model 45 or corrected sensor information obtained by correcting the sensor information, and the extracted feature is input to the model 45 to obtain an output.

The model 45 may be any general machine learning model, and an example thereof is a neural network. Other examples thereof include a branching tree, a support vector machine, and Gaussian process regression, and a regression model and a classification model for general use can be used depending on the purpose of the model 45,

In addition, an example of the output of the model 45 is the quality of machining performed by the machining device from which the sensor information to be input to the model 45 is acquired, the quality being quantified. Other examples thereof include the degree of anomaly of the machining device from which the sensor information to be input to the model 45 is acquired, anomaly determination information of the machining device, the degree of wear of the tool, and a value of the machining parameter.

Regarding the labels to be recorded in the database 5, it is necessary to record the labels corresponding to outputs of the model 45, and the sensor information acquired by the observation unit 33 needs to be information related to the labels.

In addition, the observation unit 33 generally samples a sensor signal obtained from the sensor 331 at regular time intervals and outputs the sensor signal as sensor information. The observation unit 33 can further determine whether the machining operation is being performed and output the sensor information only during the machining operation, or can output the sensor information when the start or the end of a specific operation is detected. The same applies to the observation unit 43 of the second machining device 4 that uses the model 45.

As described above, the model 45 learns the relationship between the sensor information and the labels. Specific examples of the sensor information, the labels, and the model 45 will be described.

As an example, a case will be described where the first machining device 3 and the second machining device 4 are turning devices.

In a turning device, a workpiece is attached to a rotating spindle, and a tool is pressed against the workpiece to thereby shave the workpiece. At that time, vibration called “chattering” may occur depending on a material, a rotation speed, and the amount of cutting of the workpiece. In order to detect this “chattering”, an acceleration sensor is attached to the tool to collect sensor information. At the time of collecting the sensor information, it is desirable to acquire various types of Sensor information at the time of occurrence of “chattering” and at the time of normal machining by variously changing the machining parameter. The sensor information at the time of occurrence of “chattering” is labeled as “chattering”, and the sensor information at the time of normal machining is labeled as “normal”. At that time, the acquired sensor information is time-series data, and the labels are associated with the time-series data, that is, the sensor information, on the basis of the time of occurrence of “chattering”. Therefore, by sampling time-series data having a constant time width from the sensor information, a data pair can be obtained in which the time-series data thus sampled and a label correspond to each other. The model 45 learns a relationship of the data pair, that is, a relationship between the time-series data thus sampled and the label, thereby being able to learn a relationship between time-series data of the acceleration sensor attached to the tool and the “chattering”. After the learning of the model 45 is completed, in the turning device, the time-series data of the acceleration sensor attached to the tool, that is, the sensor information is input to the model 45, and thereby an output as to whether “chattering” has occurred is obtained, and “chattering” can be automatically detected. Furthermore, when “chattering” occurs, machining can be stopped or the machining parameter can be changed.

In addition, as another example, a case will be described where the first machining device 3 and the second machining device 4 are laser cutting devices that are a type of laser machining devices.

A laser cutting device cuts a workpiece by irradiating the workpiece with laser that focuses near a surface of the workpiece. Therefore, in a laser machining device such as a laser cutting device, the laser corresponds to a tool. When irradiated with the laser, the workpiece is heated and emits light, so that time-series data of an optical sensor that captures the light emission of the workpiece can be used as sensor information in order to acquire the state of machining. Examples of a machining result at the time of laser cutting include normal machining, dross which is a melt adhering to a back surface of the workpiece, a scratch which is unevenness appearing on a cut surface, burning in which a cut portion is not penetrated and a melt blows up. At the time of collecting the sensor information, it is desirable to acquire pieces of sensor information each corresponding to one of various machining results by variously changing the machining parameter. Then, the type of the machining result is attached as a label. In a case where a label is attached to the time-series data of the optical sensor, a machining result and time are associated with each other from time-series data of a machining position and a machining result for the machining position, and then time of the optical sensor and time of the machining result are associated with each other, and thereby the machining results, that is, the labels, and the sensor information, that is, the time-series data of the optical sensor, are associated with each other. By sampling time-series data having a constant time width from the sensor information, a data pair can be obtained in which the time-series data thus sampled and the label correspond to each other. The model 45 learns a relationship of the data pair, that is, a relationship between the time-series data thus sampled and the label, thereby being able to learn a relationship between time-series data of the optical sensor and the machining results. After the learning of the model 45 is completed, in the laser cutting device, the time-series data of the optical sensor that captures the light emission of the workpiece, that is, the sensor information is input to the model 45, and thereby prediction of a machining result can be obtained as an output during machining. Furthermore, in a case where the predicted machining result is not favorable, machining can be stopped or the machining parameter can be changed.

In addition, as another example, a case will be described where the first machining device 3 and the second machining device 4 are die-sinking electrical discharge machining devices that are a type of electrical discharge machining devices.

In the die-sinking electrical discharge machining device, a workpiece is machined by an electrical discharge phenomenon generated by bringing a discharge electrode closer to the workpiece, and applying a voltage between the workpiece and the discharge electrode. Therefore, in the electrical discharge machining device, the discharge electrode and the electrical discharge phenomenon to be generated correspond to a tool.

The die-sinking electrical discharge machining device includes a drive unit for changing a relative distance between the discharge electrode and the workpiece. An example of the drive unit is a linear motor, and in that case, the position of the discharge electrode is acquired by a linear encoder. In this example, a current flowing through the linear motor and the position of the discharge electrode are used as sensor information.

As an anomaly of the die-sinking electrical discharge machining device, for example, there may be a case where the position of the discharge electrode cannot be adjusted well due to lack of grease in a sliding portion of the linear motor, anomalous heat generation of the motor, or the like. In order to detect such an anomaly, sensor information is acquired in a state in which the anomaly is reproduced, and labeled as anomalous. In addition, sensor information at the time of normal operation is acquired, and labeled as normal. Then, the model 45 is caused to learn an association relationship between the sensor information and the labels. After the learning of the model 45 is completed, it is possible to detect in the die-sinking electric discharge machining device whether the linear motor is normal or anomalous by inputting, to the model 45, the current of the linear motor and the position of the discharge electrode, that is, the sensor information.

As described above, by setting the observation unit and the labels depending on the characteristics of the machining device, collecting the sensor information indicating the observation result and the labels, and causing the model 45 to learn the relationship between the sensor information and the labels, the model 45 can be utilized in various applications.

The second machining device 4 as a second machining device is a machining device that utilizes the model 45 created by using the first machining device 3. The second machining device 4 is a machining device which is similar to the first machining device 3 and is an individual different from the first machining device 3, and machines the workpiece 42 by using the tool 41 in accordance with a machining parameter and a machining program. The observation unit 43 of the second machining device 4 observes sensor information similar to that of the observation unit 33 of the first machining device 3.

The second machining device 4 further includes the correction function 44 created by the learning device 1 and the model 45 created by using the first machining device 3. In the second machining device 4, in a case where the correction function 44 is created by the learning device 1, the correction function 44 is applied to the sensor information acquired by the observation unit 43 to obtain corrected sensor information. Then, the corrected Sensor information is input to the model 45 to obtain an output of the model 45. Note that, in a case where the correction function 44 is not provided or in a case where a user selects not to use the correction function 44, the sensor information acquired by the observation unit 43 is directly input to the model 45 to obtain an output of the model 45. In a case where the user is allowed to select whether to use the correction function 44, the second machining device 4 further includes an input unit that receives selection by the user.

By allowing the user to select whether to use the correction function 44, for example, in a case where the correction by the correction function 44 does not meet a purpose of utilization of the model 45, it is possible to immediately return to the original state in which the correction function 44 is not used. At that time, it is desirable that the second machining device 4 include a display unit that performs comparative display of outputs, i.e., an output obtained as a result of input, to the model 45, of corrected sensor information which is sensor information after correction obtained by applying the correction function 44 to the sensor information, and an output obtained as a result of input of the sensor information to the model 45, so that the user can determine whether the correction of the sensor information by the correction function 44 is appropriate.

Alternatively, a plurality of candidates for the correction function 44 are created, a candidate that provides an appropriate output of the model 45 is selected by the user from among the candidates, and the selected candidate may be used as the correction function 44. Consequently, the user can select the correction function 44 more suitable for the purpose of utilization of the model 45.

Furthermore, by providing a storage unit in the second machining device 4 and storing the sensor information acquired by the observation unit 43 therein, it is possible to check, by using the stored sensor information, whether correction by the correction function 44 is appropriate. Providing the storage unit that stores the sensor information can skip machining for checking whether correction by the correction function 44 is appropriate, and can reduce consumption of the workpiece and wear of the tool. Furthermore, if a plurality of pieces of sensor information are stored in the storage unit, the output of the model 45 can be checked in a plurality of machining states, and the correction function 44 can be more appropriately selected,

In the machining system 100 illustrated in FIG. 1, the second machining device 4 includes the model 45, and the first machining device 3 does not include the model 45. However, the first machining device 3 may also include the model 45, and the model 45 may be utilized to perform, for example, determination of the quality of machining by the first machining device 3. Since the model 45 has learned the association relationship between the sensor information output by the observation unit 33 of the first machining device 3 and the labels, the first machining device 3 does not include a correction function similar to the correction function 44 included in the second machining device 4, or the correction function included in the first machining device 3 outputs the input sensor information as it is without correcting the input sensor information.

The learning device 1 learns the correction function 44 used by the second machining device 4. FIG. 5 is a flowchart illustrating an example of an operation of the learning device 1. The learning device 1 repeatedly executes steps S1 to S3 illustrated in FIG. 5 to learn the correction function 44.

In the learning of the correction function 44, the learning device 1 first acquires an observation result of an operation of the first machining device 3 (step S1). In detail, the learning device 1 acquires sensor information output from the observation unit 33 when the first machining device 3 is operated with the reference machining parameter 2 as a machining parameter, and records the acquired sensor information in the recording unit 11 as first reference information.

Next, the learning device 1 acquires an observation result of an operation of the second machining device 4 in which the same machining parameter as that of the first machining device 3 is set (step S2). In detail, in the learning device 1, the reference information acquisition unit 12 acquires, as second reference information, sensor information output from the observation unit 43 when the second machining device 4 is operated with the reference machining parameter 2 as a machining parameter.

Next, the learning device 1 learns a correction function used in a process in which the observation result of the operation of the second machining device 4 is corrected and caused to approximate the observation result of the operation of the first machining device 3 (step S3). In detail, in the learning device 1, in a case where the correction function learning unit 13 applies the correction function 44 to the second reference information to obtain the second reference information after correction, the correction function 44 is learned so that features of the second reference information after correction are caused to approximate features of the first reference information.

Here, the sensor information recorded as the first reference information in the recording unit 11 may be, among pieces of the sensor information acquired by the model creation device 50 to create the model 45, sensor information in a case where the machining parameter used at the time of machining is the same as the reference machining parameter 2. In addition, a machining parameter may be selected from among machining parameters corresponding to the sensor information acquired for creating the model 45, and set as the reference machining parameter 2. Use of the sensor information already acquired for creating the model 45 makes it possible to skip re-execution by the first machining device 3 of machining in which the reference machining parameter 2 is set.

In addition, in a case where the nature of the sensor information changes due to a difference between machining programs and the change affects the output of the model 45, it is desirable to prepare a reference machining program which is a machining program used as a reference, similarly to the reference machining parameter 2, and obtain the first reference information and the second reference information by using the reference machining parameter 2 and the reference machining program. Use of the reference machining program can eliminate a difference between the first reference information and the second reference information caused by a difference between the machining program used by the first machining device 3 when acquiring the first reference information and the machining program used by the second machining device 4 when acquiring the second reference information. As a result, it is possible to learn a more accurate correction function 44 and to further reduce errors in the output of the model 45 in a case of using the correction function 44 in the second machining device 4, than in a case where different machining programs are used.

The operation of the correction function learning unit 13 of the learning device 1 according to the first embodiment will be described in more detail. In the first embodiment, the first reference information and the second reference information are time-series data of a sensor signal.

There may be various methods in which the correction function learning unit 13 learns the correction function 44 so that the features of the second reference information after correction are caused to approximate the features of the first reference information.

In one example, the correction function 44 can be a low-pass filter for the time-series data. Regarding other examples of the correction function 44, there are a method in which the correction function 44 is a high-pass filter or a band-pass filter, and a method in which the correction function 44 is a function that performs processes of multiplication by a constant, addition of an offset, and the like, and it is also possible to combine these methods.

In the learning of the correction function 44, in one example, the correction function 44 that adds an offset to the second reference information such that an average value of the second reference information after correction coincides with an average value of the first reference information, is learned. Other examples thereof include a method for learning the correction function 44 that multiplies the second reference information so that the average value of the second reference information after correction coincides with the average value of the first reference information, and a method for learning parameters of the correction function so as to cause the feature extracted from the second reference information after correction and the feature extracted from the first reference information to approximate each other.

Here, the feature is a quantity indicating a feature of a sensor signal, and is, for example, a statistic such as an average value, a variance value, a standard deviation value, a median value, a maximum value, a minimum value, a crest factor, or the number of peaks of the sensor signal. In addition, the feature may be a result of a frequency analysis, a result of a filter bank analysis (results of a frequency analysis summarized in a certain frequency range), a result of a cepstrum analysis, or the like. For extraction of these features, a general feature extraction method can be used. In a case where a plurality of values are used as the feature, it is only required that, for example, parameters of the correction function 44 are learned so that the sum of absolute values of differences between respective features extracted from the second reference information after correction and respective features extracted from the first reference information is reduced, or parameters of the correction function 44 are learned so that the weighted sum of squares of the differences between the respective features extracted from the second reference information after correction and the respective features extracted from the first reference information is reduced.

A general machine learning method can be used for learning the parameters of the correction function 44. That is, the correction function learning unit 13 determines the parameters of the correction function 44 by the machine learning method. For example, the correction function learning unit 13 can learn the parameters of the correction function by the Newton method such that the sum of squares of differences between the features extracted from the second reference information after correction and the features extracted from the first reference information is reduced, or can use a general optimization method such as a conjugate gradient method, a Bayesian optimization method, a stochastic gradient descent method, particle swarm optimization (PSO), a random search method, or the like. Regarding the optimization method, an appropriate method is selected in consideration of the shape of the correction function 44 and the number of parameters, the numbers of features of the first reference information and the number of features of the second reference information after correction, and natures thereof.

In a case where the first reference information and the second reference information have different labels, it is not possible to determine whether a difference between the features of the first reference information and the features of the second reference information has occurred due to a difference between the labels or due to individual differences between tools, workpieces, sensors, and the like of the first machining device 3 and the second machining device 4. When the difference has occurred due to the difference between the labels, there may be a case where the individual differences between tools, workpieces, sensors, and the like of the first machining device 3 and the second machining device 4 cannot be corrected by the correction function 44.

Therefore, it is desirable to record, in the recording unit 11, the first reference information and the label in association with each other, and learn the correction function 44 in a case where the label corresponding to the second reference information acquired by the reference information acquisition unit 12 coincides with the recorded label corresponding to the first reference information. Consequently, it is possible to determine that the difference occurred between the features of the first reference information and the features of the second reference information has occurred due to the individual differences between tools, workpieces, sensors, and the like of the first machining device 3 and the second machining device 4. In consequence, the correction function learning unit 13 can create the correction function 44 capable of correcting the influence of the individual differences between tools, workpieces, sensors, and the like of the first machining device 3 and the second machining device 4, that is, the difference between the sensor information obtained by the first machining device 3 and the sensor information obtained by the second machining device 4, more accurately than in a case where whether labels are coincident with each other is not checked.

There may be pluralities of pieces of the first reference information and the second reference information. Hereinafter, the plurality of pieces of the first reference information are set as a first group, and the plurality of pieces of the second reference information are set as a second group. The sensor information sampled at regular time intervals in the observation unit 33 and the observation unit 43, or given first reference information and second reference information sampled at certain time intervals can be respectively set as the first group and the second group. In addition, also in a case where machining is performed a plurality of times with the reference machining parameter 2, and in a case where a plurality of sets of machining parameters are designated as the reference machining parameter 2, there are pluralities of pieces of the first reference information and the second reference information, which are set as the first group and the second group, respectively.

When a plurality of sets of machining parameters are designated as the reference machining parameter 2, machining with respective machining parameters set as the reference machining parameter 2 is performed by the first machining device and the second machining device to obtain respective pieces of the first reference information and respective pieces of the second reference information, that is, the first group and the second group.

The correction function learning unit 13 uses the first group and the second group to learn parameters of the correction function so as to cause the distribution of the features extracted from the second reference information after correction to approximate the distribution of the features extracted from the first reference information. That is, the correction function learning unit 13 determines the parameters of the correction function 44 so that an inter-distribution distance, i.e., a distance between the distribution of the features extracted from the second reference information after correction and the distribution of the features extracted from the first reference information is reduced.

With the use of the plurality of pieces of the first reference information and the plurality of pieces of the second reference information, it is possible to cause the features of the second reference information after correction and the features of the first reference information to approximate each other more accurately than in a case where only one piece of the first reference information and only one piece of the second reference information are used. Therefore, the correction function learning unit 13 can learn the accurate correction function 44, and errors in the output of the model 45 when the correction function 44 is used in the second machining device 4 can be further reduced.

In addition, since the correction function is learned on the basis of machining in a plurality of different states by designating a plurality of sets of machining parameters as the reference machining parameter 2, the correction function learning unit 13 can learn the correction function 44 having high versatility as compared with a case where one machining parameter is designated as the reference machining parameter 2, and errors in the output of the model 45 when the correction function 44 is used in the second machining device 4 can be reduced.

Here, as the inter-distribution distance described above, a general one can be used, and examples thereof include Kullback-Leibler (KL) divergence, Jensen-Shannon (JS) divergence, histogram intersection, L1 distance, L2 distance, Pearson distance, and relative Pearson distance. Furthermore, when calculating the distance, a general inter-distribution distance approximation method may be used.

The distribution of the features can also be considered as a probability density function. For example, a general probability density function estimation method such as a histogram method, a kernel density estimation method, a maximum likelihood method for a parametric model, a Bayesian estimation method for a parametric model, or a method using a mixture distribution can be used. A probability density function estimation method and an inter-distribution distance calculation method are selected together, and each of the selected methods is used by the correction function learning unit 13.

Even when there are a plurality of pieces of the first reference information and a plurality of pieces of the second reference information, it is effective to check whether the labels are coincident with each other in the same manner as described above. The correction function learning unit 13 respectively extracts, as a first reference group and a second reference group, the first reference information and the second reference information associated with the same machining parameter and the same label from the first group and the second group. Then, the correction function learning unit 13 sets the distribution of the features of the first reference information included in the first reference group as the features of a first reference information group, sets the distribution of the features of the second reference information included in the second reference group as the features of a second reference information group, and learns the correction function 44 so that the features of the second reference information group after correction are caused to approximate the features of the first reference information group.

Consequently, it is possible to determine that the difference occurred between the features of the first reference information and the features of the second reference information has occurred due to the individual differences between tools, workpieces, sensors, etc. of the first machining device 3 and the second machining device 4. In consequence, the correction function learning unit 13 can create the correction function 44 capable of correcting the influence of the individual differences between tools, workpieces, sensors, etc. of the first machining device 3 and the second machining device 4, that is, the difference between the sensor information obtained by the first machining device 3 and the sensor information obtained by the second machining device 4, more accurately than when whether labels are coincident with each other is not checked.

At that time, if there is unevenness in the number of pieces of data between the first reference group and the second reference group regarding the sets of respective machining parameters as the reference machining parameter 2 and the labels, in a case of obtaining the distribution (probability density function), the unevenness in the number of pieces of data results in unevenness in the distribution (probability density function), which may affect the learning of the correction function 44. That is, the learned correction function may not be able to accurately correct the individual differences between tools, workpieces, sensors, and the like of the first machining device 3 and the second machining device 4.

Therefore, the correction function learning unit 13 extracts the first reference information and the second reference information corresponding to the same machining parameter and the same label from the first group and the second group so that the first reference information and the second reference information have the same ratio, and sets the first reference information and the second reference information as the first reference group and the second reference group, respectively. For example, suppose that machining parameters A and B are included in the reference machining parameter and a label assigned to the sensor information is any of L1 and L2, in a case where the correction function learning unit 13 extracts the first reference information of the machining parameter A and the label L1, the first reference information of the machining parameter A and the label L2, the first reference information of the machining parameter B and the label L1, and the first reference information of the machining parameter B and the label L2 at a ratio of 1:2:1:2, the correction function learning unit 13 also extracts the second reference information of the machining parameter A and the label L1, the second reference information of the machining parameter A and the label L2, the second reference information of the machining parameter B and the label L1, and the second reference information of the machining parameter B and the label L2 at a ratio of 1:2:1:2. At that time, it is also possible to extract the first reference information and the second reference information corresponding to the same machining parameter and the same label so that the number of pieces of the first reference information and the number of pieces of the second reference information are equal to each other, and set the first reference information and the second reference information as the first reference group and the second reference group, respectively. Then, the correction function learning unit 13 sets the distribution of the features of the first reference information included in the first reference group as the features of a first reference information group, sets the distribution of the features of the second reference information included in the second reference group as the features of a second reference information group, and learns the correction function 44 so that the features of the second reference information group after correction are caused to approximate the features of the first reference information group.

Consequently, it is possible to eliminate the unevenness in distribution due to the unevenness in the number of pieces of data in the sets of respective machining parameters and the labels between the first reference group and the second reference group. Therefore, as compared with when the first reference information and the second reference information corresponding to the same machining parameter and the same label are extracted as the first reference group and the second reference group, respectively, the individual differences between tools, workpieces, sensors, and the like of the first machining device 3 and the second machining device 4 can be corrected more accurately than in a case where whether labels are coincident with each other is not checked.

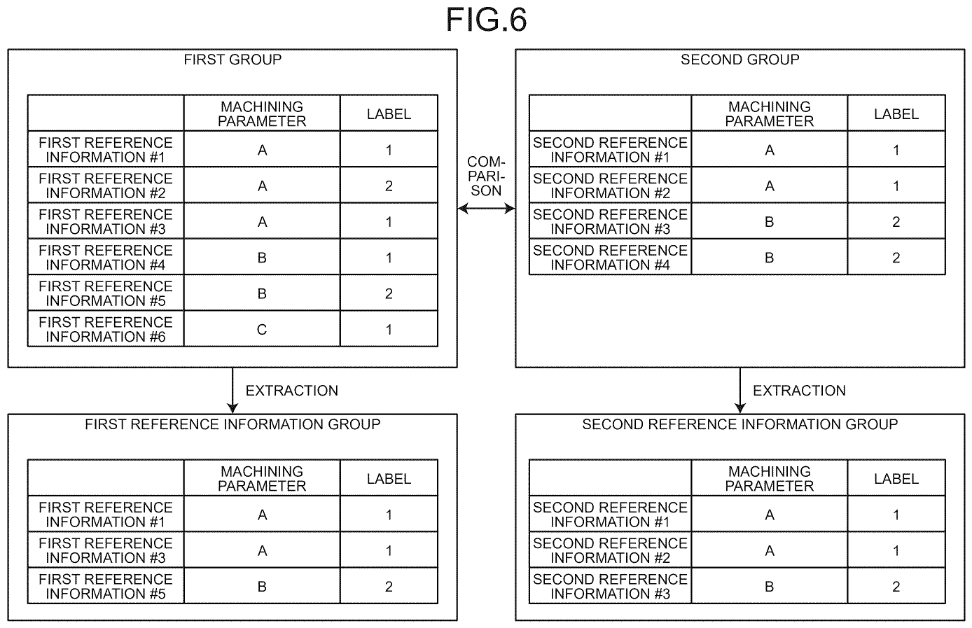

With reference to FIG. 6, a specific example of an operation will be described in which the correction function learning unit 13 extracts the same number of pieces of the first reference information and the second reference information corresponding to the same machining parameter and the same label from the first group and the second group, respectively, and sets the first reference information and the second reference information as the first reference information group and the second reference information group, respectively. Note that FIG. 6 is a diagram for explaining an example of an operation in which the correction function learning unit 13 of the learning device 1 selects data to be used for learning of the correction function 44.

In the example illustrated in FIG. 6, in the first group, six pieces of first reference information #1 to #6 are associated with machining parameters A to C and labels 1 to 2. In the second group, four pieces of second reference information #1 to #4 are associated with the machining parameters A to B and the labels 1 to 2.

In that case, when the first group and the second group are compared with each other, the first reference information and the second reference information that are associated with the same machining parameter and the same label in the first group and the second group, are those in which the machining parameter is A and the label is 1 and those in which the machining parameter is B and the label is 2.

Since there are two pieces of reference information in each of which the machining parameter is A and the label is 1 in each of the first group and the second group, the correction function learning unit 13 adds these to the first reference information group and the second reference information group. Specifically, the correction function learning unit 13 extracts first reference information #1 and first reference information #3 from the first group, adds first reference information #1 and first reference information #3 to the first reference information group, and extracts second reference information #1 and second reference information #2 from the second group, and adds second reference information #1 and Second reference information #2 to the second reference information group.

In addition, regarding a piece of reference information in which the machining parameter is B and the label is 2, one piece of the reference information is present in the first group and two pieces thereof are present in the second group, and therefore, in a case of extracting the same number of pieces of the reference information, the correction function learning unit 13 appropriately selects one of the pieces thereof from the second group. Note that the selection may be performed at random, or may be performed at will. Specifically, the correction function learning unit 13 extracts first reference information #5 from the first group, adds first reference information #5 to the first reference information group, and extracts second reference information #3 from the second group, and adds second reference information #3 to the second reference information.

In addition, in a case where the data acquisition for learning of the model 45 is performed by a plurality of first machining devices 3, that is, in a case where there are a plurality of first machining devices 3, regarding the first reference information of each first machining device 3, it is also possible to extract the features from respective pieces of the first reference information, and the average value or the median of the features of respective pieces of the first reference information can be treated as the features extracted from the first reference information. In one example, with features as an average value, the correction function learning unit 13 learns the parameters of the correction function 44 so that the average value extracted from the second reference information after correction is caused to approximate the average value of respective pieces of the first reference information.

In the learning of the correction function 44 in the present embodiment, it is not necessary to store the entire database 5 used at the time of creating the model 45, and only the first reference information needs to be recorded in the recording unit 11 of the learning device 1. Therefore, the learning can be performed even in a case where the storage capacity of the recording unit 11 is small.

As other methods for correcting an individual difference between the machining devices, there may be a method in which sensor information for learning is corrected depending on a machining device to which the model 45 is applied and learning of the model 45 is performed again, and a method in which sensor information is acquired for each machining device and learning of the model 45 is performed. However, in these methods, in order to perform learning of the model 45, a large number of pieces of data are recorded and learning processes using the large number of pieces of data are performed, and therefore a large storage capacity is required, a calculation load is large, and it takes time for the processes.

On the other hand, the learning of the correction function 44 in the present embodiment is performed with the first reference information and the second reference information obtained by the machining with the reference machining parameter 2, and therefore can be realized with a small storage capacity. Furthermore, since the number of pieces of data to be learned is small, a calculation load is small, and the processes can be performed at high speed.

In addition, the correction function 44 may be learned so that outputs obtained as a result of input of the first reference information and the second reference information after correction to the model 45 coincide with each other. However, as the model 45, a non-linear model such as a neural network or a branching tree is often used. Therefore, when learning the correction function 44, in order to obtain the relationship between the output of the correction function 44 and the output of the model 45, it is necessary to obtain a large number of outputs of the model 45 with respect to outputs obtained as a result of input of the second reference information to candidates for the correction function 44, which makes it difficult to learn the correction function 44.

On the other hand, since the learning of the correction function 44 in the present embodiment is performed with the first reference information and the second reference information obtained by machining using the reference machining parameter 2, it is not necessary to calculate the output of the model 45 for learning of the correction function 44, and the first reference information and the second reference information to which the correction function 44 is applied directly correspond to each other. Therefore, as compared with a case where the correction function 44 is learned so that outputs obtained as a result of input of the first reference information and the second reference information after correction to the model 45 coincide with each other, the amount of calculation is reduced, and the correction function 44 can be learned easily.

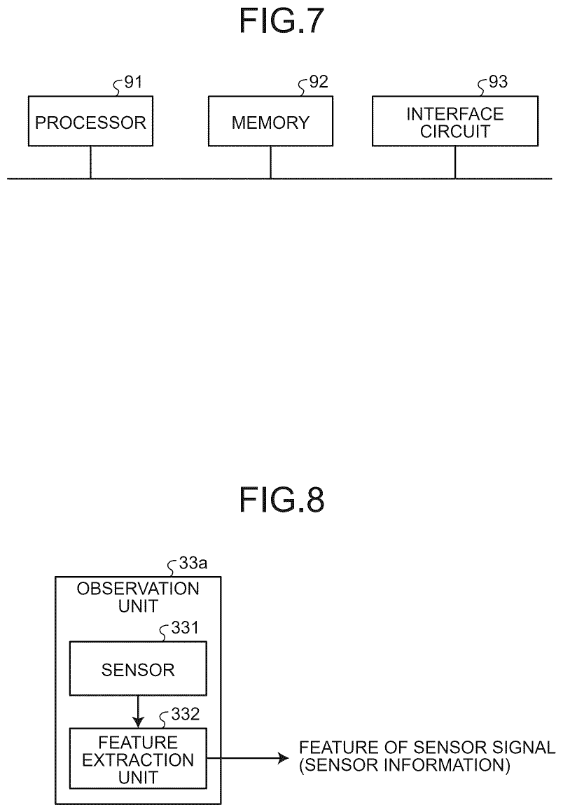

Next, a hardware configuration of the learning device 1 will be described. FIG. 7 is a diagram illustrating an example of hardware that realizes the learning device 1. The learning device 1 can be realized by a processor 91, a memory 92, and an interface circuit 93 illustrated in FIG. 7.

The processor 91 is a central processing unit (CPU, also referred to as a processing device, an arithmetic device, a microprocessor, a microcomputer, or a digital signal processor (DSP)), system large scale integration (LSI), or the like. The memory 92 is a random access memory (RAM), a read only memory (ROM), an erasable programmable read only memory (EPROM), an electrically erasable programmable read only memory (EEPROM (registered trademark)), a hard disk drive, or the like. The interface circuit 93 is a circuit for the learning device 1 to exchange data with an external device such as the first machining device 3 or the second machining device 4. The interface circuit 93 may include a circuit that is connected to a network and performs, for example, transmission and reception of data to and from other devices via the network.

The reference information acquisition unit 12 and the correction function learning unit 13 of the learning device 1 are realized by the processor 91 executing programs for operating as these components. The programs for operating as the reference information acquisition unit 12 and the correction function learning unit 13 are stored in the memory 92 in advance. The processor 91 reads the programs from the memory 92 and executes the programs, thereby operating as the reference information acquisition unit 12 and the correction function learning unit 13. The recording unit 11 is realized by the memory 92.

It is assumed that the programs for operating as the reference information acquisition unit 12 and the correction function learning unit 13 are stored in the memory 92 in advance, but there is no limitation thereto. The above programs may be supplied to a user of the learning device 1 in a state of being written in a recording medium such as a compact disc (CD)-ROM or a digital versatile disc (DVD)-ROM, and installed on the memory 92 by the user. In that case, the hardware that realizes the learning device 1 further includes a reading device for reading the programs from the recording medium. The programs may be installed by connecting the reading device to the interface circuit 93. Furthermore, the above programs may be provided from a server via the network.

As described above, the learning device 1 according to the present embodiment learns the relationship between the first reference information and the second reference information by using the first reference information which is the sensor information obtained by observing the machining operation of the first machining device 3 in which the reference machining parameter 2 is set and the second reference information which is the sensor information obtained by observing the machining operation of the second machining device 4 in which the reference machining parameter 2 is set, and the learning device 1 generates the correction function 44 that corrects the sensor information obtained by the second machining device 4 so that the sensor information obtained when the second machining device 4 performs the machining operation using the same machining parameter as that of the first machining device 3 is caused to approximate the sensor information obtained by the first machining device 3. Consequently, the learning model that determines the operation result of the first machining device 3 or the like on the basis of the sensor information can also be used for determination of the operation result of the second machining device 4 or the like. That is, it is possible to prevent the determination accuracy of the learning model from deteriorating when the learning model that has performed learning by observing the operation of the first machining device 3 is applied to the second machining device 4.

### Second Embodiment

In a second embodiment, differences from the first embodiment will be mainly described. Note that, in the figures used in the description of the present embodiment, components denoted by the same reference numerals and not particularly described are similar to those described in the first embodiment.

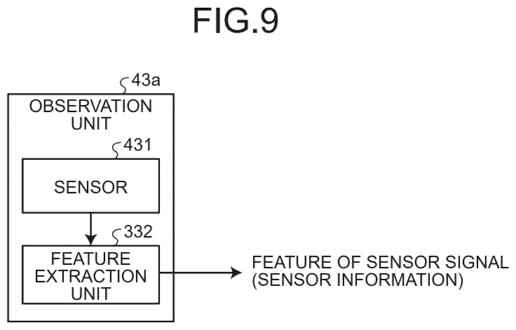

The observation unit 33 included in the first machining device 3 and the observation unit 43 included in the second machining device 4 of the machining system 100 described in the first embodiment are different in the second embodiment. Specifically, the observation unit 33 is replaced with an observation unit 33a illustrated in FIG. 8, and the observation unit 43 is replaced with an observation unit 43a illustrated in FIG. 9.

In the following description, the machining system, the first machining device, the second machining device, and the learning device according to the second embodiment are referred to as a machining system 100a, a first machining device 3a, a second machining device 4a, and a learning device la, respectively, in order to be distinguished from those in the first embodiment.

FIG. 8 is a diagram illustrating an exemplary configuration of the observation unit 33a included in the first machining device 3a of the machining system 100a according to the second embodiment. FIG. 9 is a diagram illustrating an exemplary configuration of the observation unit 43a included in the second machining device 4a of the machining system 100a according to the second embodiment.

The observation unit 33a of the first machining device 3a includes the sensor 331 and a feature extraction unit 332, and the observation unit 43a of the second machining device 4a includes the sensor 431 and the feature extraction unit 332. Note that the content of the process is intended by the feature extraction unit 332, and the feature extraction unit 332 is denoted by the same reference sign in the sense that a process is executed to extract the feature in both the observation unit 33a and the observation unit 43a. The feature extraction unit 332 can also be provided outside the observation units 33a and 43a as long as the order of processes performed on sensor signals output from the sensors 331 and 431 is not changed.

The feature extraction unit 332 of the observation unit 33a receives a sensor signal output from the sensor 331, extracts a feature from the sensor signal, and outputs the feature of the sensor signal as sensor information. Similarly, the feature extraction unit 332 of the observation unit 43a receives a sensor signal output from the sensor 431, extracts a feature from the sensor signal, and outputs the feature of the sensor signal as sensor information.

In addition, the observation units 33a and 43a generally sample sensor signals obtained from the sensors 331 and 431 at regular time intervals, and output features of the sensor signals thus sampled as sensor information. The observation units 33a and 43a can further determine whether the machining operation is being performed, and output the sensor information only during the machining operation, or can sample sensor signals and extract features when the start or the end of a specific operation is detected, and output the features as sensor information.

In the second embodiment, the sensor information is a feature of a sensor signal. Therefore, as described in the first embodiment, the model 45 that has learned the relationship between the sensor information and the labels is a model that has learned the relationship between the features of the sensor signals and the labels. Similarly, the correction function 44 is a function that corrects the features of the sensor signals. Therefore, the correction function 44 performs, on the features of the sensor signals, processes such as addition of an offset with respect to each feature, multiplication by a constant, parallel movement in a feature space, rotation in the feature space, and a combination of these processes. The correction function 44 is desirably a function which is bijective to the feature space.

A method for creating the correction function 44 can be similar to that described in the first embodiment by interpreting “the features of the first reference information” and “the features of the second reference information” described in the first embodiment as “first reference information” and “second reference information”, respectively.

In the learning device la according to the second embodiment, the recording unit 11 records the first reference information which is the feature of the sensor signal measured using the reference machining parameter 2 by the first machining device 3a, the reference information acquisition unit 12 acquires the second reference information which is the feature of the sensor signal when machining using the reference machining parameter 2 is executed by the second machining device 4a, and the correction function learning unit 13 learns the correction function 44 so that the second reference information after correction is caused to approximate the first reference information.

As described above, in the machining system 100a according to the present embodiment, the observation unit 33a of the first machining device 3a and the observation unit 43a of the second machining device 4a each include the feature extraction unit 332 that extracts features of sensor signals. According to the learning device la of the second embodiment, it is satisfactory as long as sensor information which is a feature of a sensor signal is recorded in the recording unit 11. Since the data capacity of a feature of a sensor signal is generally smaller than the data capacity of the sensor signal, the storage thereof can be performed with a storage capacity smaller than that in the case of storing the sensor signal. In addition, for a similar reason, also in the learning of the correction function 44, the amount of calculation required for learning is reduced and the processes can be performed at high speed as compared with the case of learning the correction for the sensor signal.

Furthermore, when a correction function that corrects a sensor signal is learned as in the first embodiment, learning is performed by applying a temporary correction function to the sensor signal, performing feature extraction, and then comparing the features, but when the feature is directly corrected as in the second embodiment, it is not necessary to extract the feature for comparison. Therefore, in the second embodiment, the learning of the correction function 44 can be easily performed as compared with the case where the sensor signal is corrected as in the first embodiment.

### Third Embodiment

In a third embodiment, differences from the first and second embodiments will be mainly described. Note that, in the figures used in the description of the present embodiment, components denoted by the same reference numerals and not particularly described are similar to those described in the first embodiment.

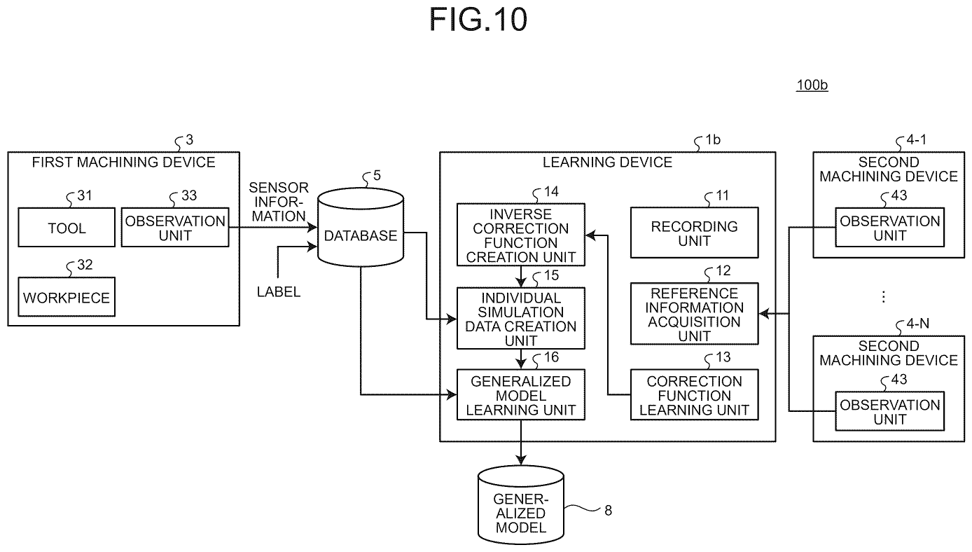

FIG. 10 is a diagram illustrating an exemplary configuration of a machining system 100b according to the third embodiment. The machining system 100b includes a learning device 1b, the first machining device 3, N (N is an integer of 1 or more) second machining devices 4-1 to 4-N, the database 5, and a generalized model 8. The second machining devices 4-1 to 4-N are each a machining device similar to the second machining device 4 described in the 1.5 first embodiment (see FIG. 1). In FIG. 10, regarding the second machining devices 4-1 to 4-N, components other than the observation unit 43 are not depicted. In the following description, the second machining devices 4-1 to 4-N may be collectively referred to as second machining devices 4. The learning device 1b includes the recording unit 11, the reference information acquisition unit 12, the correction function learning unit 13, an inverse correction function creation unit 14, an individual simulation data creation unit 15, and a generalized model learning unit 16. The learning device 11b has a configuration obtained by adding the inverse correction function creation unit 14, the individual simulation data creation unit 15, and the generalized model learning unit 16 to the learning device 1 according to the first embodiment. In addition, the learning device 1b uses the database 5 described in the first embodiment.

Here, individual differences between tools, workpieces, sensors, and the like are considered to be present in respective second machining devices 4. Even if there are these individual differences, the learning device 1b according to the third embodiment creates the generalized model 8 which is a model having a small influence on output and high generalization performance. Note that the generalized model 8 is applied to the second machining devices 4 and predicts an operation result of the second machining devices 4. An example of the operation result is a machining result.

Similarly to the first embodiment, the recording unit 11 records the first reference information which is sensor information acquired from the observation unit 33 of the first machining device 3. Although not depicted in FIG. 10, similarly to the first embodiment, the first reference information is sensor information obtained when the first machining device 3 executes the machining operation with the reference machining parameter 2.

The reference information acquisition unit 12 acquires the sensor information output from the observation unit 43 of each of the second machining devices 4-1 to 4-N as the second reference information. The sensor information acquired as the second reference information is sensor information obtained when the second machining devices 4-1 to 4-N each execute the machining operation using the reference machining parameter 2.

The correction function learning unit 13 uses the first reference information recorded in the recording unit 11 and the second reference information acquired by the reference information acquisition unit 12 to learn a correction function by a learning method similar to that in the first embodiment.

The inverse correction function creation unit 14 creates an inverse correction function which is an inverse function of the correction function learned by the correction function learning unit 13. Note that the correction function learned by the correction function learning unit 13 is a reversible function.

The individual simulation data creation unit 15 creates the individual simulation data by using the inverse correction function created by the inverse correction function creation unit 14. Specifically, the individual simulation data creation unit 15 extracts the sensor information and a corresponding label from the database 5 in which the sensor information acquired by the first machining device 3 and the labels are recorded, applies each inverse correction function to the sensor information to create individual simulation information, and creates the individual simulation data in association with the label corresponding to the sensor information. The individual simulation data created by the individual simulation data creation unit 15 is used by the generalized model learning unit 16.

The generalized model learning unit 16 creates the generalized model 8 on the basis of the sensor information registered in the database 5 and the individual Simulation data created by the individual simulation data creation unit 15. Specifically, the generalized model learning unit 16 extracts the sensor information from the database 5, extracts the individual simulation information from the individual simulation data, and learns a relationship between the extracted sensor information and the extracted individual simulation information and the label corresponding thereto, thereby creating the generalized model 8.

The generalized model 8 may be any general machine learning model, and an example thereof is a neural network. Other examples thereof include a branching tree and a support vector machine, and a regression model and a classification model for general use can be used depending on the purpose of the model. In addition, the output of the generalized model 8 is, in one example, the quality of machining that has been quantified. Other examples thereof include the degree of anomaly of the machining device, anomaly determination information of the machining device, the degree of wear of the tool, and a value of the machining parameter.

A part or all of the learning device 1b may be included in each second machining device 4 or may be provided outside each second machining device 4. Alternatively, a configuration can be employed in which each second machining device 4 is connected to a cloud via a network, and all or a part of the learning device 1b is implemented by a processing circuit of a cloud server. For example, when a part of the learning device 1b is configured by the cloud server via network connection, each of the recording unit 11, the reference information acquisition unit 12, the correction function learning unit 13, and the inverse correction function creation unit 14 can be provided in the cloud server connected to the network, or can be provided in each second machining device 4. The individual simulation data creation unit 15 and the generalized model learning unit 16 can also be freely disposed as long as the data of the database 5 can be used. Alternatively, a configuration may be employed in which with respect to each second machining device 4, the second reference information acquired by the reference information acquisition unit 12, the correction function learned by the correction function learning unit 13, or the inverse correction function created by the inverse correction function creation unit 14 are gathered manually and collected in an electronic computer connected to the database 5, and all or a part of processes of the learning device 1b is performed by the electronic computer.

The learning device 1b can be configured with at least one second machining device 4, but it is desirable to prepare more than two second machining devices 4 to configure the learning device 1b. This is to configure the learning device 1b so as to be able to learn individual differences among various second machining devices 4, and the more second machining devices 4 there are, the higher generality is obtained for the generalized model 8 that can be created by the generalized model learning unit 16.

The generalized model 8 created by the learning device 1b is applied to the second machining devices 4 via a network or manually. The second machining devices 4 to which the generalized model 8 is applied may include the second machining device 4 from which the learning device 1b has not acquired the second reference information used to create the generalized model 8. That is, the generalized model 8 can be installed on a new second machining device 4. When the second machining device 4 includes the generalized model 8 instead of the model 45 described in the first embodiment, the correction function 44 of the second machining device 4 including the generalized model 8 outputs the sensor information input from the observation unit 43 as it is and inputs the sensor information to the generalized model 8.

As described above, in the learning device 1b according to the present embodiment, the inverse correction function creation unit 14 creates the inverse correction function which is an inverse function of the correction function created by the correction function learning unit 13 described in the first embodiment. The individual simulation data creation unit 15 creates the individual simulation data by using the inverse correction function, the sensor information obtained by observing the state of the first machining device 3, and the labels attached to the sensor information. The generalized model learning unit 16 creates the generalized model 8 on the basis of the Sensor information and the individual simulation data. According to the present embodiment, even when a plurality of second machining devices 4 are present and have individual differences, it is possible to reduce the influence of the individual differences to obtain highly accurate output by applying the generalized model 8. That is, the generalized model 8 with high generality can be created.

When a part of the components of the learning device 1b, for example, the correction function learning unit 13 is included in each of the second machining devices 4-1 to 4-N, the learning device 1b acquires the correction function created by each of the second machining devices 4-1 to 4-N instead of the second reference information, and the inverse correction function creation unit 14 creates the inverse correction function by using the acquired correction functions. In addition, when the correction function learning unit 13 and the inverse correction function creation unit 14 are included in each of the second machining devices 4-1 to 4-N, the learning device 1b acquires the inverse correction function created by each of the second machining devices 4-1 to 4-N instead of the second reference information, and the individual simulation data creation unit 15 creates the individual simulation data by using the acquired inverse correction functions.

In the learning device 1b according to the present embodiment, only the second reference information, the correction function, or the inverse correction function is collected from at least one second machining device 4, and the number of pieces of data collected from each second machining device 4 is smaller than that when various types of sensor information are collected from each second machining device 4. That is, the capacity of data collected for learning can be reduced. Therefore, the time required to collect data is short, and the necessity for a large storage area is eliminated. In addition, since there is no need to form a high-speed network, it is easy to acquire data from each second machining device 4.

The configurations described in the above embodiments are merely examples and can be combined with other known technology, the embodiments can be combined with each other, and part of the configurations can be omitted or modified without departing from the gist thereof.

### REFERENCE SIGNS LIST

1, 1b learning device; 2 reference machining parameter; 3 first machining device; 4, 4-1, 4-N second machining device; 5 database; 6 model learning unit; 8 generalized model; 11 recording unit; 12 reference information acquisition unit; 13 correction function learning unit; 14 inverse correction function creation unit; 15 individual simulation data creation unit; 16 generalized model learning unit; 31, 41 tool; 32, 42 workpiece; 33, 33a, 43, 43a observation unit; 44 correction function; 45 model; 50 model creation device; 100, 100b machining system; 331, 431 sensor; 332 feature extraction unit.

1. A learning device comprising, when a model is used in a second machining device, the model being learned by associating sensor information acquired by observation circuitry of a first machining device and labels corresponding to the sensor information, the first machining device being a machining device that performs machining in accordance with machining parameters, and includes the observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device:
recording circuitry to record, as first reference information, the sensor information when machining with a reference machining parameter that is one of the machining parameters is executed by the first machining device;
reference information acquisition circuitry to acquire, as second reference information, the sensor information when machining with the reference machining parameter is executed by the second machining device; and
correction function learning circuitry to learn a correction function to be used, when the sensor information is subjected to correction and then input to the model in the second machining device, for the correction so that a feature of the second reference information after correction is caused to approximate a feature of the first reference information, wherein
the correction function learning circuitry
performs the learning by using a distribution of features of the first reference information as the feature of the first reference information and using a distribution of features of the second reference information as the feature of the second reference information.

2.-3. (canceled)

4. A learning device comprising, when a model is used in a second machining device, the model being learned by associating sensor information acquired by observation circuitry of a first machining device and labels corresponding to the sensor information, the first machining device being a machining device that performs machining in accordance with machining parameters, and includes the observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device:
recording circuitry to record, as first reference information, the sensor information when machining with a reference machining parameter that is one of the machining parameters is executed by the first machining device;
reference information acquisition circuitry to acquire, as second reference information, the sensor information when machining with the reference machining parameter is executed by the second machining device; and
correction function learning circuitry to learn a correction function to be used, when the sensor information is subjected to correction and then input to the model in the second machining device, for the correction so that a feature of the second reference information after correction is caused to approximate a feature of the first reference information, wherein the recording circuitry further records the labels corresponding to the first reference information, and
the correction function learning circuitry selects, from the recording circuitry, the first reference information corresponding to a same label as a label associated with the second reference information acquired by the reference information acquisition circuitry, and performs the learning by using the first reference information that is selected and the second reference information acquired by the reference information acquisition circuitry.

5. A learning device comprising, when a model is used in a second machining device, the model being learned by associating sensor information acquired by observation circuitry of a first machining device and labels corresponding to the sensor information, the first machining device being a machining device that performs machining in accordance with machining parameters, and includes the observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device:
recording circuitry to record, as first reference information, the sensor information when machining with a reference machining parameter that is one of the machining parameters is executed by the first machining device;
reference information acquisition circuitry to acquire, as second reference information, the sensor information when machining with the reference machining parameter is executed by the second machining device; and
correction function learning circuitry to learn a correction function to be used, when the sensor information is subjected to correction and then input to the model in the second machining device, for the correction so that a feature of the second reference information after correction is caused to approximate a feature of the first reference information, wherein
the reference machining parameter is a plurality of sets of the machining parameters,
the recording circuitry records, as a first group, the first reference information that is each piece of the sensor information when the first machining device executes machining with each machining parameter included in the reference machining parameter, and the labels each corresponding to one of pieces of the first reference information,
the reference information acquisition circuitry acquires, as a second group, the second reference information that is each piece of the sensor information when the second machining device executes machining with each machining parameter included in the reference machining parameter, and the labels corresponding to each of pieces of the second reference information, and
the correction function learning circuitry
extracts, from the first group and the second group, the first reference information and the second reference information that are created when machining is performed with the same machining parameter and are associated with the same label, as a first reference group and a second reference group, respectively,
uses a distribution of features of the first reference information included in the first reference group as the feature of the first reference information, and
performs the learning by using a distribution of features of the second reference information included in the second reference group as the feature of the second reference information.

6. The learning device according to claim 5, wherein
the correction function learning circuitry respectively extracts, from the first group and the second group, the first reference information and the second reference information that are created when machining is performed with the same machining parameter and are associated with the same label so that the first reference information and the second reference information have a same ratio, and sets the first reference information and the second reference information as the first reference group and the second reference group.

7. The learning device according to claim 5, wherein
the correction function learning circuitry respectively extracts, from the first group and the second group, a same number of pieces of the first reference information and the second reference information that are created when machining is performed with the same machining parameter and are associated with the same label, and sets the first reference information and the second reference information as the first reference group and the second reference group.

8. A learning device comprising, when a model is used in a second machining device, the model being learned by associating sensor information acquired by observation circuitry of a first machining device and labels corresponding to the sensor information, the first machining device being a machining device that performs machining in accordance with machining parameters, and includes the observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device:
recording circuitry to record, as first reference information, the sensor information when machining with a reference machining parameter that is one of the machining parameters is executed by the first machining device;
reference information acquisition circuitry to acquire, as second reference information, the sensor information when machining with the reference machining parameter is executed by the second machining device; and
correction function learning circuitry to learn a correction function to be used, when the sensor information is subjected to correction and then input to the model in the second machining device, for the correction so that a feature of the second reference information after correction is caused to approximate a feature of the first reference information, wherein
the reference information acquisition circuitry acquires, as the second reference information, the sensor information when machining with the reference machining parameter is executed by the second machining device, a number of the second machining device being at least one,
the correction function learning circuitry individually learns the correction function for each of the second machining devices,
the learning device comprises:
inverse correction function creation circuitry to create an inverse correction function that is an inverse function of the correction function;
individual simulation data creation circuitry to create individual simulation data by creating individual simulation information by applying the inverse correction function to the sensor information acquired by the observation circuitry of the first machining device, and associating the individual simulation information with labels corresponding to the sensor information used to create the individual simulation information; and
generalized model learning circuitry to learn a relationship between the sensor information acquired by the observation circuitry of the first machining device and the individual simulation information, and the labels corresponding thereto to create a generalized model, and
sets the generalized model as the model to be used by the second machining device.

9. A numerical control device that comprises the learning device according to claim 1 and controls a machining device operating as the second machining device, the numerical control device comprising:
input circuitry to receive, from a user, selection whether to input, to the model to be used in the second machining device, the sensor information before the correction using the correction function is performed or the sensor information after the correction using the correction function is performed.

10. The numerical control device according to claim 9, comprising:
a display to, when the input circuitry receives the selection from the user, display an output of the model when the sensor information before the correction is performed is input, and an output of the model when the sensor information after the correction is performed is input.

11. A numerical control device that comprises the learning device according to claim 1 and controls a machining device operating as the second machining device, wherein
the numerical control device corrects the sensor information acquired by the second machining device in operation with the correction function, and inputs the sensor information after correction to the model to obtain an output.

12. A numerical control device that comprises the generalized model created by the learning device according to claim 8 and controls a machining device operating as the second machining device, wherein
the numerical control device inputs the sensor information acquired by the second machining device in operation to the generalized model to obtain an output.

13. A machining result prediction method when a model is used in a second machining device, the model being learned by associating sensor information acquired by observation circuitry of a first machining device and labels corresponding to the sensor information, the first machining device being a machining device that performs machining in accordance with machining parameters, and includes observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device, the machining result prediction method comprising:
recording, as first reference information, the sensor information when machining with a reference machining parameter that is one of the machining parameters is executed by the first machining device;
acquiring, as second reference information, the sensor information when machining with the reference machining parameter is executed by the second machining device;
learning a correction function to be used, when the sensor information is subjected to correction and then input to the model in the second machining device, for the correction so that a feature of the second reference information after correction is caused to approximate a feature of the first reference information;
correcting the sensor information acquired from the second machining device during machining; and
predicting a result of machining by the second machining device on a basis of the sensor information corrected by the correction function, wherein in the correction function learning,
the learning is performed by using a distribution of features of the first reference information as the feature of the first reference information and using a distribution of features of the second reference information as the feature of the second reference information.

14. A machining system comprising:
the learning device according to claim 1,
the first machining device; and
the second machining device including observation circuitry similar to the observation circuitry of the first machining device and a model that performs prediction on a basis of the sensor information acquired by the observation circuitry.

15. A numerical control device that comprises the learning device according to claim 4 and controls a machining device operating as the second machining device, the numerical control device comprising:
input circuitry to receive, from a user, selection whether to input, to the model to be used in the second machining device, the sensor information before the correction using the correction function is performed or the sensor information after the correction using the correction function is performed.

16. A numerical control device that comprises the learning device according to claim 5 and controls a machining device operating as the second machining device, the numerical control device comprising:
input circuitry to receive, from a user, selection whether to input, to the model to be used in the second machining device, the sensor information before the correction using the correction function is performed or the sensor information after the correction using the correction function is performed.

17. A numerical control device that comprises the learning device according to claim 8 and controls a machining device operating as the second machining device, the numerical control device comprising:
input circuitry to receive, from a user, selection whether to input, to the model to be used in the second machining device, the sensor information before the correction using the correction function is performed or the sensor information after the correction using the correction function is performed.

18. The numerical control device according to claim 15, comprising:
a display to, when the input circuitry receives the selection from the user, display an output of the model when the sensor information before the correction is performed is input, and an output of the model when the sensor information after the correction is performed is input.

19. The numerical control device according to claim 16, comprising:
a display to, when the input circuitry receives the selection from the user, display an output of the model when the sensor information before the correction is performed is input, and an output of the model when the sensor information after the correction is performed is input.

20. The numerical control device according to claim 17, comprising:
a display to, when the input circuitry receives the selection from the user, display an output of the model when the sensor information before the correction is performed is input, and an output of the model when the sensor information after the correction is performed is input.

21. A numerical control device that comprises the learning device according to claim 4 and controls a machining device operating as the second machining device, wherein
the numerical control device corrects the sensor information acquired by the second machining device in operation with the correction function, and inputs the sensor information after correction to the model to obtain an output.

22. A numerical control device that comprises the learning device according to claim 5 and controls a machining device operating as the second machining device, wherein
the numerical control device corrects the sensor information acquired by the second machining device in operation with the correction function, and inputs the sensor information after correction to the model to obtain an output.

23. A machining result prediction method when a model is used in a second machining device, the model being learned by associating sensor information acquired by observation circuitry of a first machining device and labels corresponding to the sensor information, the first machining device being a machining device that performs machining in accordance with machining parameters, and includes observation circuitry that acquires, during machining, any one of a sensor signal and a feature of the sensor signal as sensor information, the sensor signal indicating an observation result of at least one of a state of a workpiece and a state of a machining device, the second machining device being the machining device different from the first machining device, the machining result prediction method comprising:
recording, as first reference information, the sensor information when machining with a reference machining parameter that is one of the machining parameters is executed by the first machining device;
acquiring, as second reference information, the sensor information when machining with the reference machining parameter is executed by the second machining device;
learning a correction function to be used, when the sensor information is subjected to correction and then input to the model in the second machining device, for the correction so that a feature of the second reference information after correction is caused to approximate a feature of the first reference information;
correcting the sensor information acquired from the second machining device during machining; and
predicting a result of machining by the second machining device on a basis of the sensor information corrected by the correction function, wherein
in the recording, the labels corresponding to the first reference information are recorded, and
in the correction function learning, the first reference information corresponding to a same label as a label associated with the second reference information is selected, and the learning is performed by using the first reference information that is selected and the second reference information acquired.

24. A machining system comprising:
the learning device according to claim 4,
the first machining device; and
the second machining device including observation circuitry similar to the observation circuitry of the first machining device and a model that performs prediction on a basis of the sensor information acquired by the observation circuitry.
